(19) United States
(12) Patent Application Publication
(10) Pub. No.: US 2023/0034309 A1
(43) Pub. Date: Feb. 2, 2023

(54) MAGNETIC CORE STRUCTURE AND ELECTROMAGNETIC COUPLING DEVICE

(71) Applicant: SHANGHAI BRIGHT POWER SEMICONDUCTOR CO., LTD., Shanghai (CN)

(72) Inventor: Shungen SUN, Shanghai (CN)

(21) Appl. No.: 17/866,583

(22) Filed: Jul. 18, 2022

(30) Foreign Application Priority Data
Jul. 28, 2021 (CN) 202121741435.3

(51) Int. Cl. H01F 3/14; H01F 27/24

(52) U.S. Cl. CPC H01F 3/14; H01F 27/24

(57) ABSTRACT

A magnetic core structure and an electromagnetic coupling device are provided by the present application. Wherein the magnetic core structure includes a first magnetic core and a second magnetic core; the first magnetic core includes a main portion and two side pillars fixedly connected to the main portion. Convex structures are set on end surfaces of the two side pillars away from the main portion, respectively; and the convex structures abut against a surface of the second magnetic core after the first magnetic core and the second magnetic core are assembled together, so as to form a gap between the end surfaces of the two side pillars away from the main portion and the surface of the second magnetic core. The magnetic core structure and the electromagnetic coupling device disclosed by the present application can precisely control an air gap between the two magnetic cores.

### CROSS-REFERENCE TO RELATED APPLICATION

This disclosure claims priorities to a Chinese patent application with an application date of Jul. 28, 2021, an application number of 202121741435.3, and an application title of “MAGNETIC CORE STRUCTURE AND ELECTROMAGNETIC COUPLING DEVICE”, which is incorporated by reference in the present application in its entirety.

### FIELD OF DISCLOSURE

The present application relates to a technical field of electromagnetic coupling devices, and specifically to a magnetic core structure and an electromagnetic coupling device.

### BACKGROUND OF DISCLOSURE

With development of science and technology, all kinds of mobile devices are equipped with batteries. Electromagnetic coupling devices are used to charge the batteries. Electromagnetic coupling devices use a principle of electromagnetic induction to transmit electric energy or signals from one circuit to another circuit.

FIG. 1 is a schematic structural diagram of a magnetic core structure in an electromagnetic coupling device in prior art. The magnetic core structure 100′ generally comprises two magnetic cores, as shown in FIG. 1. For some topological structures, there is no need to add an air gap between the two magnetic cores. For other application occasions, air gaps are added between the two magnetic cores. How to add air gaps has always been a big problem. The main challenge is how to ensure consistency and processability of the air gaps. In prior art, an air gap is generally realized by adding an insulating gasket 50′; namely, the insulating gasket 50′ is set between the two magnetic cores, and is stuck to a first magnetic core 10′ and a second magnetic core 20′ by glue 60′, thereby separating the two magnetic cores to form an air gap 4′. However, the above-mentioned process is very complicated, and a total height of the air gap 4′ is equal to a thickness of the insulating gasket 50′ plus a thickness of the glue 60′, an amount of glue 60′ will seriously affect a size of the air gap 4′, making it difficult to control precision of the size of the air gap 4′.

### SUMMARY OF DISCLOSURE

In order to overcome deficiencies of the prior art, a purpose of the present application is to provide a magnetic core structure to solve a problem of poor precision control of an air gap set between two magnetic cores in the magnetic core structure in prior art.

The purpose of the present application adopts following technical scheme to realize:

A magnetic core structure, which comprises: a first magnetic core and a second magnetic core. The first magnetic core includes a main portion and two side pillars fixedly connected to the main portion; convex structures are set on end surfaces of the two side pillars away from the main portion, respectively; wherein the convex structures abut against a surface of the second magnetic core after the first magnetic core and the second magnetic core are assembled together, so as to form a gap between the end surfaces of the two side pillars away from the main portion and the surface of the second magnetic core.

Optionally, the main portion of the first magnetic core, the two side pillars of the first magnetic core, and the convex structures of the first magnetic core are integrally formed.

Optionally, at least a part of a cross-sectional area of each convex structure is less than a cross-sectional area of each side pillar.

Optionally, the second magnetic core has a concave portion located on the surface of the second magnetic core corresponding to each convex structure, and a part of each convex structure is accommodated in a corresponding concave portion after the first magnetic core and the second magnetic core are assembled together; wherein a height of each convex structure is greater than a depth of the corresponding concave portion.

Optionally, each convex structure comprises a plurality of convex portions, and a slit is formed between adjacent two convex portions; and the side pillars abut against the surface of the second magnetic core through at least one of the plurality of convex portions.

Optionally, the second magnetic core has a plurality of concave portions located on the surface of the second magnetic core, and each convex portion is accommodated in a corresponding concave portion respectively after the first magnetic core and the second magnetic core are assembled together; wherein a height of each convex portion is greater than a depth of the corresponding concave portion.

Optionally, glue is provided in the gap for fixing the two side pillars and the second magnetic core.

The present application further provides an electromagnetic coupling device, and the electromagnetic coupling device comprises any one of the above-mentioned magnetic core structures.

Optionally, the electromagnetic coupling device is a transformer.

Optionally, the electromagnetic coupling device further comprises a circuit board. The circuit board comprises a first through hole and a second through hole; and the two side pillars of the first magnetic core penetrate through the first through hole and the second through hole, respectively; an annular wiring is arranged on the circuit board and comprises a first annular wiring and a second annular wiring; the first annular wiring is formed around the first through hole to form a first coil, and the second annular wiring is formed around the second through hole to form a second coil.

Compared with the prior art, the magnetic core structure and the electromagnetic coupling device having the magnetic core structure are provided by embodiments of the present application. The magnetic core structure comprises a first magnetic core and a second magnetic core. The first magnetic core comprises a main portion and two side pillars fixedly connected to the main portion. Convex structures are set on end surfaces of the two side pillars away from the main portion, respectively. The convex structures abut against a surface of the second magnetic core after the first magnetic core and the second magnetic core are assembled together, so as to form a gap between the end surfaces of the two side pillars away from the main portion and the surface of the second magnetic core. The gap constitutes an air gap of the magnetic core structure. When the first magnetic core and the second magnetic core are assembled together, under a condition of external force, glue will automatically spread into space without the convex structures, so that a total height of the air gap is approximately equal to a height of the convex structures. Based on this, a size of the gap between ends of the side pillars and the second magnetic core, that is, a size of the air gap of the magnetic core structure, can be adjusted by a size of the convex structures. An implementation method is simple, and adjusting precision of the air gap is easier to be controlled, and an adverse effect caused by excessive glue coating is avoided at a same time.

### BRIEF DESCRIPTION OF DRAWINGS

In order to illustrate technical solutions in embodiments of the present application more clearly, accompanying drawings that need to be used in a description of the embodiments will be briefly introduced as follows. Obviously, the drawings in following description are only some embodiments of the present application. For those skilled in the art, other drawings can also be obtained according to the disclosed drawings without creative efforts.

FIG. 1 is a schematic structural diagram of a magnetic core structure in prior art.

FIG. 2 is a schematic structural diagram of a magnetic core structure provided by an embodiment of the present application.

FIG. 3 is a schematic structural diagram of another magnetic core structure provided by an embodiment of the present application.

FIG. 4 is a schematic structural diagram of another magnetic core structure provided by an embodiment of the present application.

FIG. 5 is a schematic structural diagram of another magnetic core structure provided by an embodiment of the present application.

FIG. 6 is a schematic structural diagram of yet another magnetic core structure provided by an embodiment of the present application.

FIG. 7 is a schematic structural diagram of an electromagnetic coupling device provided by an embodiment of the present application.

FIG. 8 is a schematic structural diagram of another electromagnetic coupling device provided by an embodiment of the present application.

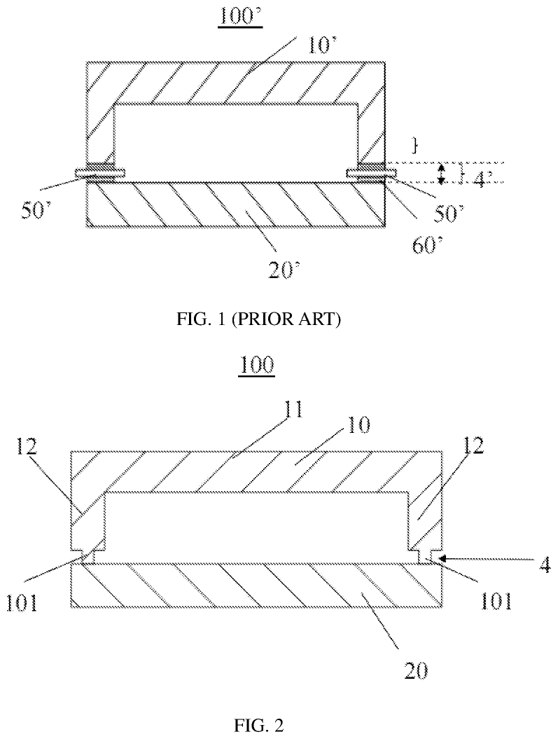

### DETAILED DESCRIPTION OF PREFERRED EMBODIMENTS

The above description is only an overview of a technical scheme of the present application. In order to have a clearer understanding of technical means of the present application, it can be implemented in accordance with contents of the specification; and to make above-mentioned and other purposes, features, and advantages of the present application more obvious and understandable, the following specific examples are better and explained in detail in conjunction with the accompanying drawings.

In the description of the present application, it should be noted that terms “installing”, “connected with each other”, “connecting” should be understood in a broad sense, unless otherwise expressly specified and defined. For example, it may be a fixed connection, a detachable connection, or an integral connection; it may be a mechanical connection, an electrical connection, or communication with each other. It may be directly connected or indirectly connected through an intermediate medium, or it may be a connection within two elements or an interaction between two elements. For those skilled in the art, the specific meanings of the above-mentioned terms in the present application can be understood according to specific situations.

FIG. 2 is a schematic structural diagram of a magnetic core structure provided by an embodiment of the present application. As shown in FIG. 2, a magnetic core structure 100 is provided by the present application. The magnetic core structure 100 comprises a first magnetic core 10 and a second magnetic core 20. The first magnetic core 10 and the second magnetic core 20 are coupled to each other during actual operation. The first magnetic core 10 comprises a main portion 11 and two side pillars 12 fixedly connected to the main portion 11. An extending direction of the side pillars 12 is perpendicular to an extending direction of the main portion 11. Convex structures 101 are set on end surfaces of the two side pillars 12 away from the main portion 11, respectively. The convex structures 101 abut against a surface of the second magnetic core 20 after the first magnetic core 10 and the second magnetic core 20 are assembled together, so as to form a gap between the end surfaces of the two side pillars 12 away from the main portion 11 and the surface of the second magnetic core 20. The gap constitutes an air gap 4 of the magnetic core structure 100.

For example, when assembling the first magnetic core 10 with the second magnetic core 20, glue is used for bonding and fixing. When an external force is applied, the glue will automatically spread into space without the convex structures 101. Therefore, the convex structures 101 will eventually abut against the surface of the second magnetic core 20 after the first magnetic core 10 and the second magnetic core 20 are assembled together, so that a total height of the air gap 4 is approximately equal to a height of the convex structures 101, that is, a thickness of the glue can be ignored. Based on this, a size of the gap between the end surfaces of the side pillars 12 away from the main portion 11 and the second magnetic core 20, that is, a size of the air gap 4 of the magnetic core structure, can be adjusted by a size of the convex structures 101. By adopting this technical scheme, a process of bonding insulating gaskets between two side pillars and a second magnetic core by the glue in the prior art is omitted; an implementation method is simple, precision of the air gap is easier to be controlled, and an adverse effect caused by excessive glue coating is avoided at a same time.

Optionally, magnetic cores used in the first magnetic core 10 and the second magnetic core 20 may be made of solid materials such as ferrite, amorphous alloy core, ultra-microcrystalline alloy core, iron powder core, iron silicon aluminum core, or iron silicon core. In some embodiments, magnetic cores used in the first magnetic core 10 and the second magnetic core 20 may be wound with high permeability materials such as permalloy.

Preferably, cross-sectional shapes of the two side pillars 12 of the first magnetic core 10 are preferably rectangular, but other cross-sectional shapes can also be adopted.

Preferably, each convex structure 101 is set at a geometric center of the end surface of the side pillar 12 away from the main portion 11 to ensure that the convex structures 101 on the two side pillars 12 have equal force when the convex structures 101 abut against the surface of the second magnetic core 20.

Preferably, the main portion 11 of the first magnetic core 10, the two side pillars 12 of the first magnetic core 10, and the convex structures 101 of the first magnetic core 10 are integrally formed and are made of a same magnetic material, so as to simplify a manufacturing process. A shape of each convex structure 101 can be cylindrical, conical, frustum, rectangular block, or irregular block, etc., which is not limited in the present application.

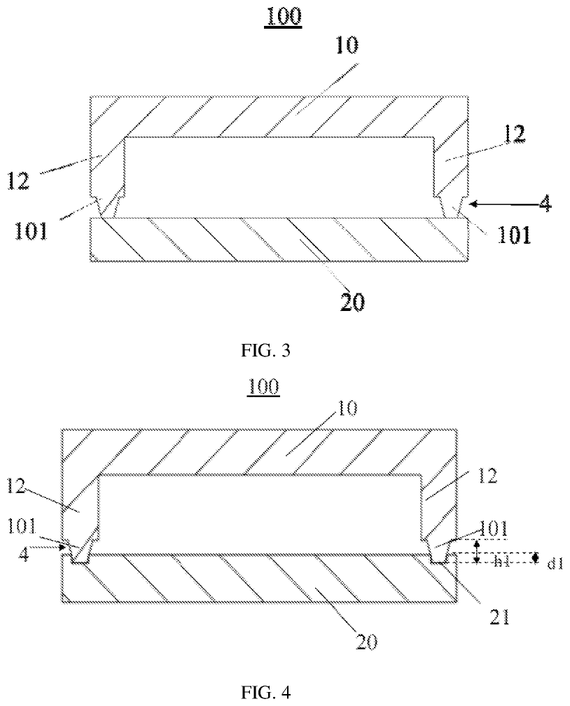

FIG. 3 is a schematic structural diagram of another magnetic core structure provided by an embodiment of the present application. As shown in FIG. 3, for example, a cross-sectional shape of a convex structure 101 is an inverted trapezoid along an extending direction of side pillars 12. At least a part of a cross-sectional area of each convex structure 101 is less than a cross-sectional area of each side pillar 12. When the convex structures 101 abut against a surface of a second magnetic core 20 after a first magnetic core 10 and the second magnetic core 20 are assembled together, a gap with a certain distance can still be formed between end surfaces of two side pillars 12 away from a main portion 11 and the surface of the second magnetic core 20. The gap with the certain distance constitutes an air gap 4 of the magnetic core structure 100 to increase leakage inductance of the magnetic core structure 100. In practical applications, shape parameters of corresponding convex structures 101, such as height or corresponding cross-sectional area, can also be designed according to an expected value of a required air gap, so that precision control of the air gap is relatively easy to achieve.

FIG. 4 is a schematic structural diagram of another magnetic core structure provided by an embodiment of the present application. As shown in FIG. 4, for example, concave portions 21 are arranged on a surface of a second magnetic core 20 corresponding to convex structures 101. Shapes of the concave portions 21 can be adapted to shapes of the convex structures 101. A part of the convex structures 101 are accommodated in corresponding concave portions 21 after a first magnetic core 10 and the second magnetic core 20 are assembled together. Setting the concave portions 21 not only can increase a contact area between glue and the first magnetic core 10, and a contact area between glue and the second magnetic core 20, but also can realize a relative position fixation of the convex structures 101 and the second magnetic core 20, so as to avoid a relative displacement of the convex structures 101 when the convex structures 101 abut against the surface of the second magnetic core 20. Specifically, as shown in FIG. 4, a height hl of each convex structure 101 is greater than a depth d1 of a corresponding concave portion 21, so that a gap with a certain distance can still be formed between end surfaces of two side pillars 12 of the first magnetic core 10 away from a main portion 11 and the surface of the second magnetic core 20. The gap constitutes an air gap 4 of the magnetic core structure.

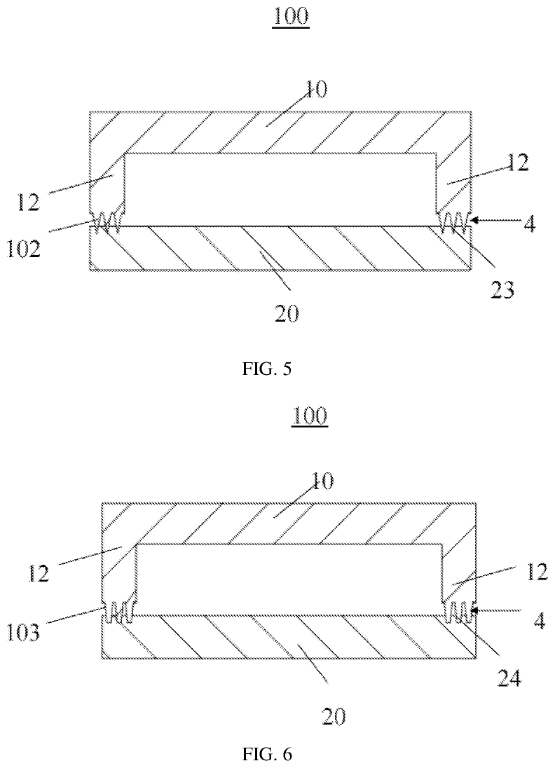

FIG. 5 is a schematic structural diagram of another magnetic core structure provided by an embodiment of the present application. FIG. 6 is a schematic structural diagram of yet another magnetic core structure provided by an embodiment of the present application. As shown in FIG. 5 and FIG. 6, a plurality of convex portions (102, 103) are arranged on end surfaces of two side pillars 12 away from a main portion 11, respectively. For example, cross-sectional shapes of the plurality of convex portions (102, 103) are in a sawtooth shape or an inverted ladder shape along an extending direction of the side pillars 12, of course, they can also be other shapes. And a slit is formed between adjacent two convex portions (102, 103). Each side pillar 12 abuts against a surface of a second magnetic core 20 through at least one convex portion (102, 103) of the plurality of convex portions (102, 103), so that a gap is formed between the end surfaces of the two side pillars 12 away from the main portion 11 and the surface of the second magnetic core 20 when the plurality of convex portions (102, 103) abut against the surface of the second magnetic core 20 after a first magnetic core 10 and the second magnetic core 20 are assembled together. The gap constitutes an air gap 4 of the magnetic core structure 100. Setting the plurality of convex portions (102, 103) can increase a contact area between glue and the first magnetic core 10, and a contact area between glue and the second magnetic core 20, so that the first magnetic core 10 and the second magnetic core 20 are better fixed.

It should be noted that heights of the plurality of convex portions (102, 103) can be same or different; and/or shapes of the plurality of convex portions (102, 103) can be same or different. The plurality of convex portions (102, 103) can be arranged at intervals or in close proximity, as long as there is the slit between the adjacent two convex portions (102, 103). The side pillars 12 may abut against the surface of the second magnetic core 20 through at least one convex portion (102, 103) of the plurality of convex portions (102, 103), when the heights of the plurality of convex portions (102, 103) are not equal to each other.

Please continue to refer to FIG. 5 and FIG. 6, preferably, a plurality of concave portions (23, 24) are arranged on the surface of the second magnetic core 20 corresponding to the plurality of convex portions (102, 103). Shapes of the plurality of concave portions (23, 24) are adapted to the shapes of the plurality of convex portions (102, 103). The plurality of convex portions can be accommodated in corresponding concave portions (23, 24) respectively after the first magnetic core 10 and the second magnetic core 20 are assembled together. Optionally, the plurality of concave portions (23, 24) are arranged in one-to-one correspondence with the plurality of convex portions (102, 103). The plurality of convex portions (102, 103) are accommodated in corresponding concave portions (23, 24) respectively, which not only can increase the contact area between the glue and the first magnetic core 10, and the contact area between the glue and the second magnetic core 20, but also realize a relative position fixation of the first magnetic core 10 and the second magnetic core 20, so as to avoid a relative displacement of the plurality of convex portions (102, 103) when the convex portions (102, 103) abut against the surface of the second magnetic core 20.

Each convex portion (102, 103) is embedded into a corresponding concave portion (23, 24). Preferably, the height of each convex portion (102, 103) is greater than a depth of the corresponding concave portion (23, 24), so that a gap with a certain distance is defined between the end surfaces of the side pillars 12 away from the main portion 11 and the surface of the second magnetic core 20. The gap constitutes the air gap 4 of the magnetic core structure 100.

It should be noted that a number of the plurality of concave portions (23, 24) may be not equal to a number of the plurality of convex portions (102, 103). A part of the convex portions (102, 103) are selected to be embedded in the concave portions (23, 24), and another part of the convex portions (102, 103) have no corresponding concave portions (23, 24). Of course, it is also possible to select a part of the concave portions (23, 24) without corresponding convex portions, and the number of the plurality of concave portions (23, 24) is greater than the number of the plurality of convex portions (102, 103). That is to say, as long as one convex portion (102, 103) of the plurality of convex portions (102, 103) is embedded into the corresponding concave portion (23, 24), and the height of the convex portion (102, 103) embedded into the corresponding concave portion (23, 24) is greater than the depth of the corresponding concave portion (23, 24), it is within the scope of protection of the present application.

Optionally, in the present application, an appearance of the first magnetic core 10 is U-shaped, and an appearance of the second magnetic core 20 is I-shaped; both the first magnetic core 10 and the second magnetic core 20 are flat, so that volume of the magnetic core structure 100 can be reduced.

An electromagnetic coupling device is further provided by embodiments of the present application. The electromagnetic coupling device includes any one of the above-mentioned magnetic core structures.

Optionally, the electromagnetic coupling device is a transformer, and this transformer can be used as a power transformer. The magnetic core structure in the transformer has an air gap. Existence of the air gap can increase leakage inductance of the transformer, and a phenomenon of magnetic saturation of the transformer under large AC current or DC current bias is avoided, and inductance can be better controlled.

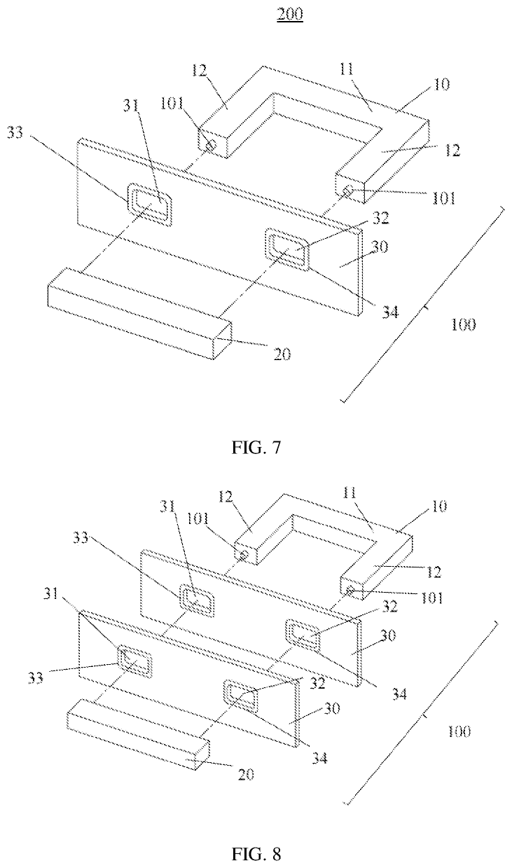

FIG. 7 is a schematic structural diagram of an electromagnetic coupling device provided by an embodiment of the present application. As shown in FIG. 7, the electromagnetic coupling device 200 includes a magnetic core structure 100 and a circuit board 30 with a first through hole 31 and a second through hole 32 arranged thereon. And a first annular wiring 33 is formed around the first through hole 31, and a second annular wiring 34 is formed around the second through hole 32. The first annular wiring 33 constitutes a first coil, and the second annular wiring 34 constitutes a second coil. Specifically, a number of the first annular wiring 33 and a number of the second annular wiring 34 can be set according to actual situations, which is not limited in the present application.

Optionally, the circuit board 30 can be a printed circuit board (PCB) or a flexible printed circuit board (FPC). An annular wiring can be formed by conductive wiring arranged on the PCB board or the FPC board, such as copper or other conductive metal film layers. By adopting the technical scheme provided by the embodiment of the present application, since there is no need to set additional coils to be wound on the magnetic core structure 100, and the annular wiring is directly made on the PCB board and FPC board as the first coil and the second coil, volume of the electromagnetic coupling device 200 can be greatly reduced.

In addition, two side pillars 12 of a first magnetic core 10 in the magnetic core structure 100 penetrate through the first through hole 31 and the second through hole 32 respectively to realize coupling with a second magnetic core 20, so that the first coil and the second coil surround the two side pillars 12 of the first magnetic core 10 respectively to form a winding. In the embodiment of the present application, the first coil is a primary coil, the second coil is a secondary coil. The first coil is electrically connected with a power supply (not shown in drawings), and the second coil is electrically connected with a signal output end (not shown in drawings). When AC power is applied to the first coil, AC magnetic flux is generated in the first magnetic core 10, that is, a number of magnetic flux intersecting a chain with the first coil changes, causing voltage (or current) to be induced in the second coil.

FIG. 8 is a schematic structural diagram of another electromagnetic coupling device provided by an embodiment of the present application. As shown in FIG. 8, in order to simplify winding of coils, a first coil and a second coil of the present application can be formed by stacking a plurality of circuit boards 30 together. As shown in FIG. 8, when the plurality of circuit boards 30 are stacked, each circuit board 30 comprises a first through hole 31 and a second through hole 32. And the first annular wiring 33 is formed around the first through hole 31, and a second annular wiring 34 is formed around the second through hole 32. The first coil is composed of a plurality of first annular wiring 33, and the second coil is composed of a plurality of second annular wiring. Two side pillars 12 of a first magnetic core 10 in a magnetic core structure 100 penetrate through the first through holes 31 and the second through holes of the plurality of circuit boards 30 to realize coupling with the second magnetic core 20, so that the first coil and the second coil surround the two side pillars 12 of the first magnetic core 10 respectively to form a winding. As a same reason, the first coil is a primary coil, the second coil is a secondary coil. The first coil is electrically connected with a power supply (not shown in drawings), and the second coil is electrically connected with a signal output end (not shown in drawings). When AC power is applied to the first coil, AC magnetic flux is generated in the first magnetic core 10, that is, a number of magnetic flux intersecting a chain with the first coil changes, causing voltage (or current) to be induced in the second coil.

In addition, since an extending direction of a main portion 11 of the first magnetic core 10 is basically parallel to a direction of a plane where the circuit board 30 is located; the main portion 11 of the first magnetic core 10 and the circuit board 30 can be bonded and fixed by glue; and the plurality of circuit boards 30 can also be fixed by insulating glue, so as to realize a position fixation between the magnetic core structure and the circuit board 30. The insulating glue can prevent coupling of coils or mutual interference of signals between two adjacent circuit boards 30.

It can be seen from the above content that the magnetic core structure and the electromagnetic coupling device having the magnetic core structure are provided by the embodiments of the present application. The magnetic core structure includes the first magnetic core and the second magnetic core. The first magnetic core includes the main portion and the two side pillars fixedly connected to the main portion. The convex structures are arranged on the end surfaces of the two side pillars away from the main portion, and the convex structures abut against the surface of the second magnetic core after the first magnetic core and the second magnetic core are assembled together, so as to form the gap between the end surfaces of the two side pillars away from the main portion and the surface of the second magnetic core. The gap constitutes the air gap of the magnetic core structure. When the first magnetic core and the second magnetic core are assembled, under a condition of external force, the glue will automatically spread into the space without the convex structures, so that the total height of the air gap is approximately equal to the height of the convex structures. Based on this, the size of the air gap of the magnetic core structure can be adjusted by the size of the convex structures. An implementation method is simple, and adjusting precision of the air gap is easier to be controlled, and an adverse effect caused by excessive glue coating is avoided at a same time.

The above-mentioned is only a preferred embodiment of the present application and is not used to limit a scope of the present application. All equal changes and modifications of shapes, structures, characteristics, and spirits described in the scope of claims of the present application shall be included in the scope of claims of the present application.

What is claimed is:

1. A magnetic core structure, comprising:
a first magnetic core comprising a main portion and two side pillars fixedly connected to the main portion; convex structures are set on end surfaces of the two side pillars away from the main portion, respectively; and
a second magnetic core;
wherein the convex structures abut against a surface of the second magnetic core after the first magnetic core and the second magnetic core are assembled together, so as to form a gap between the end surfaces of the two side pillars away from the main portion and the surface of the second magnetic core.

2. The magnetic core structure as claimed in claim 1, wherein the main portion of the first magnetic core, the two side pillars of the first magnetic core, and the convex structures of the first magnetic core are integrally formed.

3. The magnetic core structure as claimed in claim 1, wherein at least a part of a cross-sectional area of each convex structure is less than a cross-sectional area of each side pillar.

4. The magnetic core structure as claimed in claim 3, wherein the second magnetic core has a concave portion located on the surface of the second magnetic core corresponding to each convex structure, and a part of each convex structure is accommodated in a corresponding concave portion after the first magnetic core and the second magnetic core are assembled together;
wherein a height of each convex structure is greater than a depth of the corresponding concave portion.

5. The magnetic core structure as claimed in claim 1, wherein each convex structure comprises a plurality of convex portions, and a slit is formed between adjacent two convex portions; and the side pillars abut against the surface of the second magnetic core through at least one of the plurality of convex portions.

6. The magnetic core structure as claimed in claim 5, wherein the second magnetic core has a plurality of concave portions located on the surface of the second magnetic core, and each convex portion is accommodated in a corresponding concave portion respectively after the first magnetic core and the second magnetic core are assembled together;
wherein a height of each convex portion is greater than a depth of the corresponding concave portion.

7. The magnetic core structure as claimed in claim 1, wherein glue is provided in the gap for fixing the two side pillars and the second magnetic core.

8. An electromagnetic coupling device, comprising the magnetic core structure as claimed in claim 1.

9. The electromagnetic coupling device as claimed in claim 8, wherein the electromagnetic coupling device is a transformer.

10. The electromagnetic coupling device as claimed in claim 9, wherein the transformer further comprises a circuit board comprising a first through hole and a second through hole; and the two side pillars of the first magnetic core penetrate through the first through hole and the second through hole, respectively;
an annular wiring is arranged on the circuit board and comprises a first annular wiring and a second annular wiring; the first annular wiring is formed around the first through hole to form a first coil, and the second annular wiring is formed around the second through hole to form a second coil.
